(19) United States
(12) Patent Application Publication
(10) Pub. No.: US 2026/0000235 A1
(43) Pub. Date: Jan. 1, 2026

(54) COFFEE MACHINE AND METHOD FOR PREPARING A COFFEE DRINK

(71) Applicant: Coffee Vision AG, Luzern (CH)

(72) Inventor: Georg Josef Feierabend, Aarburg (CH)

(21) Appl. No.: 18/879,872

(22) PCT Filed: Jun. 30, 2023
(86) PCT No.: PCT/EP2023/068032

§ 371 Date: Dec. 30, 2024

(30) Foreign Application Priority Data
Jul. 1, 2022 (CH) CH000796/2022

(51) Int. Cl. A47J 31/36; A47J 31/42; A47J 31/46

(52) U.S. Cl. CPC A47J 31/3614; A47J 31/42; A47J 31/469

(57) ABSTRACT

A coffee machine including a machine unit with a brewing piston which is movably mounted between an initial position and a brewing position, with a piston drive which can be controlled via the control device, for moving the brewing piston from the initial position into the brewing position, with a water preparation device with a water tank, a water pump and a heating unit, for generating and delivering hot brewing water under pressure into a brewing chamber as well as with a control device for the control of the coffee machine. The coffee machine includes a locking device with at least one locking body for locking the brewing piston in the brewing position.

### BACKGROUND OF THE INVENTION

### Field of the Invention

The invention lies in the field of coffee machines and relates to a coffee machine for creating, in particular brewing a coffee drink, and to a method for brewing a coffee drink.

### Description of Related Art

A multitude of different systems of coffee machines for creating or brewing a coffee drink are known. Apart from the known capsule machines concerning which the coffee powder is fed to the coffee machine in capsules in a pre-portioned manner, there are also systems concerning which the coffee powder is filled into a coffee receiving space in a portioned manner for each brewing procedure. Regarding these systems, one differentiates between the coffee machines which operate in a semi-automatic manner, the so-called semi-automatic machines and the coffee machines operating in a fully automatic manner, the so-called bean-to-cup machines.

In particular, so-called portafilter machines are known amongst the semi-automatic machines. These are characterised by a manually removable portafilter which forms the coffee receiving space which is closed to the bottom by the brewing filter. The filling of the portafilter with coffee powder as well as the removal of coffee grounds from the portafilter after the brewing procedure is effected outside the coffee machine. For this, the portafilter is removed from the machine in a manual manner.

The fully automatic machines differ from the semi-automatic machines in that the provision of the coffee powder or the filling of the coffee receiving space with coffee powder before the brewing procedure is a fully automatically integrated procedure within the coffee machine. Furthermore, the coffee grounds are expelled into an integrated capture container in the coffee machine in a fully automatic manner after the end of the brewing procedure. Accordingly, fully automatic machines have no removable portafilter.

As a rule, the provision of the coffee powder with fully automatic machines is effected via an integrated grinder, by way of which coffee beans from a storage container of the coffee machine are freshly ground for each brewing procedure.

In particular, coffee powder in the present description is to be understood as coffee which has been ground, thus ground coffee. Coffee grounds in the present description are to be understood as the pressing residue after the brewing procedure, which is also denoted as coffee residue.

The present invention then in particular relates to fully automatically and very particularly semi-automatically operating coffee machines, such as portafilter machines. Regarding these coffee machines, the coffee powder yet needs to be subjected to a pressing in the coffee receiving space before the brewing procedure. This procedure is also called “tampering”.

The pressing of the coffee powder in the coffee receiving space is decisive for the subsequent brewing procedure, e.g. for the preparation of an espresso with crema and influences the preparation type of the brewed coffee.

It is known to effect the pressing of the coffee powder, the so-called “tampering” via a movable brewing piston which via a hand lever or in a fully automatic manner via a piston drive is advanced or moved downwards into the coffee receiving space.

Each automation step, such as e.g. the automatic driving of the brewing piston however requires additional components and assemblies, such as drives. By way of this, the construction of the coffee machines becomes increasingly complex. This on the one hand leads to a high service effort and on the other hand also to a high proneness to malfunctioning. Moreover, additional components, in particular drives render the coffee machine more expensive.

### SUMMARY OF THE INVENTION

It is the object of the present invention to provide a coffee machine with a high degree of automation, but with as few as possible drive devices for driving the different assemblies by way of a control device.

A further object lies in providing a coffee machine which permits a defined pressing of the coffee powder, even given a different filling of the portafilter with coffee powder, such pressing being controlled via a control device.

A further object lies in providing a coffee machine concerning which the movably guided brewing piston is secured against being displaced back out of the coffee receiving space during the brewing procedure due to brewing pressure in the brewing chamber. The securing means if possible should not render necessary any additional drive.

At least one object is achieved by the features of the independent claims. The dependent claims, the description and the figures in particular include embodiments and further developments of the invention.

The coffee machine according to the invention includes a machine unit with:
control device for the control of the coffee machine,
a brewing piston which is movably mounted between an initial position and a brewing position,
a piston drive which can be controlled via the control device, for moving the brewing piston from the initial position into the brewing position, and with
a water preparation device with a water tank, a water pump and a heating unit, for generating and delivering hot brewing water under pressure into a brewing chamber.

In particular, the brewing piston is movably mounted along its piston axis, i.e. axially.

The invention is characterised in that the coffee machine includes a locking device with at least one locking body for locking the brewing piston in the brewing position. In particular, the locking serves for preventing an axial movement of the brewing piston out of the brewing position in the direction of the initial position.

The brewing piston in particular is part of a brewing unit which is formed in the machine unit and includes a piston tamper. The piston tamper is arranged at the brewing side. The piston tamper in particular is connected to a piston rod which in particular is guided in a piston rod housing. The piston rod housing in particular is part of the brewing unit in the machine unit.

The brewing unit in particular together with the coffee receiving space and a brewing filter, respectively together with a portafilter device forms a brewing group.

The brewing piston in particular serves for pressing (tampering) the coffee powder which has previously been filled into a coffee receiving space, before the brewing procedure, as well as for closing the coffee receiving space and for forming a closed brewing chamber for the subsequent brewing procedure.

The coffee receiving space, respectively the coffee receiver which forms the coffee receiving space in particular is arranged in the machine unit in a stationary or immovable manner, in particular during the brewing procedure. Consequently, this correspondingly applies to the portafilter device in the case that the coffee machine is a portafilter machine.

A brewing water feed for leading brewing water into the brewing chamber can lead through the piston tamper.

The piston drive can include an electric motor. The brewing piston can thus be driven by the electric motor via a drive spindle.

The piston drive can also include a hydraulic drive, by way of which a hydraulic pressure is built up in a pressure chamber in the brewing unit via a hydraulic fluid such as water, the hydraulic pressure capable of pushing or advancing or moving the brewing piston into the brewing position. The hydraulic pressure can be generated via a pump. The hydraulic pressure can be between e.g. 2 and 3 bar.

According to a further development of the invention, the water pump of the water preparation device is part of the piston drive or forms the piston drive.

The brewing piston can be moved from the initial position into the brewing position by way of building up a (piston) water pressure which acts upon the brewing piston, by way of the water pump.

In this constellation, the water pump of the water preparation device has a double function: on the one hand brewing water is pumped into the brewing chamber by the water pump and on the other hand (piston) water for advancing the brewing piston into a pressure chamber in the brewing unit is pumped by the same water pump. Piston water is to be understood as that water which is pumped by the water pump into the piston water conduit for the purpose of building up a piston water pressure for moving the brewing piston.

In particular, the locking device can then be actuated via the piston drive. Thus, the locking device can be actuated by the hydraulic drive, in particular by the water pump of the water preparation device.

The at least one locking body of the locking device can be displaced into a locking position by way of building up a water pressure, in particular piston water pressure, which acts upon the locking device.

The at least one locking body of the locking device can be displaced into a locking position in particular in an indirect manner by way of the piston water pressure.

In particular, the locking device is a locking mechanism.

In particular, the locking device includes an actuation element which is movable parallel to the piston axis of the brewing piston. The at least one locking body is movable towards the brewing piston into a locking position by way of or via the actuation element.

In particular, the actuation element is movable parallel to the piston axis of the brewing piston by way of the hydraulic pressure, in particular fluid pressure or piston fluid pressure, such as water pressure or piston water pressure.

In particular, the coffee machine is then designed such that for initiating a brewing procedure, the piston drive in a first step moves the brewing piston into a brewing position and in a second step after reaching the brewing position actuates the locking device amid the locking of the brewing piston.

A coffee machine which is designed as a portafilter machine in particular is designed such that for initiating a brewing procedure, the piston drive in a first step moves the brewing piston into a brewing position whilst pressing the coffee powder by way of applying a pressing force and in a second step on reaching a maximal pressing force with the assumption of the brewing position actuates the locking device amid the locking of the brewing piston.

According to a further development of the invention, the piston rod housing is movably mounted along the piston axis. This interacts with the actuation element of the locking device.

The piston rod housing and the brewing piston in particular are designed and interact with one another, in a manner such that the piston drive in the first step advances the brewing piston in the axial direction toward the brewing chamber into the brewing position and subsequently in a second step displaces the piston rod housing in the opposite, axial direction amid the actuation of the locking device.

The axially movably mounted piston rod housing together with the axially movably mounted brewing piston in particular forms a pressure chamber.

The piston rod housing and the brewing piston are then in particular designed and interact with one another, in a manner such that a hydraulic pressure, in particular (piston) water pressure, which is generated in the pressure chamber advances or moves the brewing piston in the axial direction, in particular downwards towards the brewing chamber into the brewing position and subsequently moves the piston rod housing in the opposite, axial direction, in particular upwards amid the actuation of the locking device. The movement or displacement of the brewing piston and of the piston rod housing are effected in each case in particular counter to the restoring force of restoring means which exert a restoring force upon the brewing piston or the piston rod housing.

The piston rod housing in particular is not moved until the brewing piston has reached the brewing position and the hydraulic pressure in the pressure chamber increases further. This means that the hydraulic pressure for moving the piston rod housing is larger than the hydraulic pressure for moving the brewing piston into the brewing position.

In particular, the pressure chamber is arranged in an upper section of the brewing unit and very particularly above the brewing piston.

The brewing piston in particular delimits a lower section of the pressure chamber in a manner such that the piston pressure in the pressure chamber is capable of pushing or moving the brewing piston axially downwards in the direction of the coffee receiving space.

In particular, the piston rod housing delimits an upper section of the pressure chamber in a manner such that the piston pressure in the pressure chamber is capable of pushing or moving the piston rod housing axially upwards away from the coffee receiving space in the opposite direction.

The piston rod housing is displaceably mounted in particular along a longitudinal guide, respectively a vertical guide. The longitudinal guide can be effected e.g. via at least one connection screw with an in particular thread-free guide section. The at least one restoring spring is arranged in particular on the connection screw.

In particular, the piston rod housing is coupled to the actuation element, respectively is connected to this, in a manner such that the actuation element can be displaced together with the piston rod housing in the axial direction, in particular upwards, for assuming an actuation position. The actuation element can basically also be part of the piston rod housing.

The locking body is displaced into a locking position by way of the axial movement of the actuation element and locks the brewing piston. For assuming the locking position, the locking body in particular moves transversely to the piston axis or radially towards the brewing piston and in particular engages into a recess on the brewing piston.

According to a further development of the invention, the locking of the brewing piston can be created in different axial positions of the brewing piston and consequently in different axial brewing positions of the brewing piston. This is achieved for example by way of at least two or more successive recesses being arranged on the brewing piston in the axial direction.

The movement of the piston rod housing is comparatively small, in particular in comparison with the movement of the brewing piston, since the movement merely serves for actuating the locking body.

In particular, the piston rod of the brewing piston is led through a piston rod guide tube. In particular, the piston rod is led through the piston rod guide tube from the piston rod housing into a piston tamper guide housing, in which the piston tamper is arranged. The piston rod guide tube thus in particular connects the piston rod housing to the piston tamper guide housing.

The piston rod housing and the piston rod guide tube in particular are arranged in the machine unit in a stationary, i.e. immovable manner.

The piston rod guide tube can include at least one radial opening, in particular several radial openings which very particularly are arranged uniformly around the circumference of the piston rod guide tube. The at least one locking body in particular is a ball body which is led in a radial opening of the piston rod guide tube and which in the locking position engages into a recess on the piston rod, the recess being designed as a deepening. The deepening on the piston rod can be a deepening which is annularly circumferential. In particular, the actuation element is an annular body which surrounds the piston rod guide tube.

The brewing piston can interact with restoring means in particular with a restoring spring, by way of which the brewing piston can be moved back or restored from the brewing position into the initial position after the reduction of the hydraulic pressure, in particular (piston) water pressure in the pressure chamber. In particular, the restoring means are arranged in the piston rod housing.

In particular, the restoring spring can be a compression spring. The piston rod of the brewing piston can be led axially through the compression spring.

In particular, the compression spring is designed and arranged in the brewing unit, in a manner such that this spring is pressed together by way of the advancing or moving of the brewing piston in the direction of the brewing position and by way of extending moves the brewing piston back into its initial position.

According to a further development of the invention, the piston rod housing interacts with restoring means, in particular with at least one restoring spring, by way of which the piston rod housing can be moved back from the actuation position into its initial position after the reduction of the (piston) water pressure.

In particular, the at least one restoring spring can be a compression spring. In particular, the compression spring is designed and arranged in the brewing unit, in a manner such that this spring is pressed together by way of an axial movement of the piston rod housing which is opposite to the piston movement and the piston rod housing is moved back again into its initial position by way of the extending of the compression spring.

If the piston drive is formed by the water pump of the water preparation device, then the water pump in particular is hydraulically connected:
to a water tank via a feed water conduit for obtaining water,
to the brewing piston via a piston water conduit for displacing the brewing piston, and
to the brewing chamber via a brewing water conduit for brewing coffee.

In particular, the control device is designed to switch the water pump between a piston water feed and a brewing water feed.

In particular, a directional valve, such as a 3/2-way valve is arranged in the piston water conduit, the valve being designed and controllable or switchable via the control device, such that on reduction of the piston water pressure water, piston water which flows back can be led away via a discharge conduit whilst circumventing the water pump.

In particular, the discharge conduit is a return water conduit, via which piston water can flow back into the water tank. The return flow can be effected in a direct manner by way of the return water conduit leading directly into the water tank or can be effected in an indirect manner by way of the return water conduit leading into the feed water conduit.

In particular, a check valve for maintaining the built-up piston water pressure is arranged in the piston water conduit, in particular between the water pump and a directional valve.

In particular, the brewing water conduit leads to the brewing water feed on the piston tamper. A heating unit, such as a thermo-block or continuous heater, via which the brewing water flowing through the brewing water conduit can be heated, is arranged along the brewing water conduit.

In particular, a directional valve, such as a 3/2-way valve is arranged in the brewing water conduit, the valve being designed and able to be controlled or switched via the control device, such that after the brewing procedure, residual water which flows back in the direction of the water pump can be led away via a discharge conduit, i.e. into a drip tray.

According to a particular embodiment variant, the coffee machine is a portafilter machine and includes a portafilter device with a brewing filter, also called portafilter, which is removable from the machine unit. The portafilter device forms a coffee receiving space which together with the brewing piston, respectively piston tamper, which is advanced into the brewing position, forms the brewing chamber.

“Removable” in particular means that the portafilter device is completely separable from the machine unit without a permanent connection to the machine unit.

In particular, the portafilter device includes a handle for the manual attachment of the portafilter device onto the machine unit and for the manual removal of the portafilter device from the machine unit. The attachment and the removal of the portafilter device in particular are effected in a tool-free manner.

The coffee receiving space of the portafilter device in particular can be formed by a filter basket with a brewing filter, the filter basket being integrated into the portafilter housing. The coffee receiving space of the portafilter device can thus be formed by a filter basket with a brewing filter, the filter basket being fixedly built in the portafilter housing. The filter basket however can also be removable.

Since according to the present invention, the movably mounted brewing piston is advanced into the coffee receiving space of the portafilter device for pressing (tampering) the coffee powder and for closing the brewing chamber, one does not need differently large filter baskets for different quantities of coffee powder.

The attachment of the portafilter device onto the machine unit for initiating a brewing procedure can be effected via a quick-release fastener, such as a bayonet fastener, which is known from the state of the art, i.e. by way of applying and rotating in the portafilter device on the machine unit. The portafilter device however can also be insertable into the machine unit in a straight-lined manner via a linear guide device.

The portafilter device can be removed from the machine unit, in particular for removing coffee grounds after a brewing procedure. Supplementarily, the portafilter unit can also be removed from the machine unit for filling the portafilter device with coffee powder.

However, one can also envisage the portafilter device or the coffee receiving space being filled with coffee powder via a grinder which is integrated into the machine unit or the coffee machine. In particular, this also applied to fully automatic coffee machines.

This means that the machine unit or the coffee machine can include a device for delivering and in particular for producing and delivering coffee powder into the coffee receiving space.

The invention further also relates to a method for brewing a coffee drink with a coffee machine as described above. According to definition, all preparation types of coffee which are possible with a portafilter machine fall under the term coffee drink. These are e.g. black coffee, espresso, espresso lunge, ristretto, etc. Moreover, according to definition, all preparation types with milk as an addition, such as e.g. cappuccino or latte macchiato fall under the term coffee drink. For this, the coffee machine can also include a milk preparation device such as a milk frother.

For activating a brewing procedure and in particular also for the selection of the coffee preparation type, the coffee machine can include an input device, e.g. with a display.

The method is characterised in that for carrying out a brewing procedure, the brewing piston by way of the piston drive is advanced in the direction of the coffee receiving space which is filled with coffee powder, and the locking device is actuated on reaching the brewing position and the brewing piston is locked with respect to an axial movement which is directed away from the brewing chamber. Brewing water is conveyed into the brewing chamber amid the build up of a brewing water pressure by way of the water pump and the brewing procedure is carried out.

If the piston drive is effected via the water pump of the brewing water preparation device, then a piston water pressure which acts upon the brewing piston is built up by way of the water pump, by which means the brewing piston is advanced in the direction of the coffee receiving space, in particular downwards, in particular counter to the restoring force of a restoring means, into the brewing position.

The water pump obtains the (piston) water which is necessary for the build-up of a piston water pressure from the water tank via the feed water conduit and pumps this as piston water into the piston water conduit.

The piston tamper which engages into the coffee receiving space closes the coffee receiving space, by which means a closed brewing chamber is formed.

The brewing piston acts as a coffee presser or “tamper” and presses together the coffee powder in the coffee receiving space. The degree or measure of the coffee pressing which predominantly influences the type of coffee preparation can be set, in particular via the control device.

Thus, the control device can control the pressing pressure (piston pressure) which is exerted onto the coffee powder via the piston drive, respectively the water pump, on the basis of the respective settings for the coffee pressing (measure or degree of the coffee pressing).

The control of the coffee pressing can be effected on the basis of stored specification values or on the basis of specification values which are inputted or selected via the input device on the machine unit.

The pressing pressure which is exerted upon the coffee powder by the brewing piston is lower than the brewing water pressure in the brewing chamber, the brewing water pressure being exerted onto the brewing piston in the opposite direction by the brewing water during the brewing procedure.

For this reason, the brewing piston in the brewing position according to the invention is locked with respect to an axial movement which is counter to the advance direction of the brewing piston. Thanks to the locking, the piston drive in the course of a brewing procedure merely needs to muster the lower pressure force which is necessary for pressing the coffee and not a higher force which counteracts the brewing water pressure.

According to the locking device which is described further above, an actuation element is moved or displaced in an axial direction which is opposite to the advance direction of the brewing piston, in particular upwards, by way of the piston water pressure after the brewing piston has reached the brewing position. The at least one locking body is displaced radially towards the brewing piston, in particular towards the piston rod, into a locking position due to the movement of the actuation element, by which means the brewing piston is locked. “Radial” in particular also means transversely to the piston axis.

In the locking position, the at least one locking body engages into a deepening on the brewing piston, in particular on the piston rod.

For the axial movement of the actuation element, in particular the movably mounted piston rod housing, to which the actuation element is coupled or connected, is moved or displaced in an axial direction which is opposite to the advance direction of the brewing piston, in particular upwards, counter to the restoring force of the restoring means, into the actuation position by way of the piston water pressure in the pressure chamber

As mentioned, the piston water pressure is maintained during the brewing procedure, by which means the actuation element or the piston rod housing with the actuation element also remains in the actuation position and thus the locking body also remains in the locking position.

The locking device according to the invention thus has the advantage that in the case of a portafilter machine, the locking of the brewing piston is not effected until after the pressing or pressing-on of the coffee powder (tampering) in the portafilter device has been effected. Since the quantity of coffee powder and accordingly also the brewing position of the brewing piston can vary along the brewing piston axis depending on the preparation type,

For building up a brewing water pressure in the brewing chamber, the water pump obtains water from the water tank via the feed water conduit and pumps this as brewing water into the brewing water conduit.

For this, in particular the water pump is switched over from the piston water feed to the brewing water feed. This is likewise effected by way of the control device. Thanks to the check valve in the piston water conduit, the built-up piston water pressure in the piston water conduit is retained despite the switching over to the brewing water feed.

The piston water pressure is not reduced until after completion of the brewing procedure, for the purpose of lifting the locking and for moving the brewing piston back into its initial position.

The feed of the brewing water by the water pump is ended at the end of the brewing procedure and the brewing water pressure is accordingly reduced. The residual water which is present in the brewing water conduit is discharged, e.g. into a drip tray, by way of switching the directional valve at the brewing water conduit.

Moreover, for reducing the piston water pressure for the purpose of lifting the locking and restoring the brewing piston, the directional valve in the piston water conduit is switched via the control device in a manner such that the piston water is discharged via the discharge water conduit. The piston water is led back into the water tank in particular via the discharge water conduit which is designed as a return water conduit.

By way of the reduction of the piston water pressure, the actuation element or the piston rod housing with the actuation element moves back from the actuation position into the initial position on account of the restoring force of the restoring means.

By way of this, the locking of the brewing piston by way of the at least one locking body can be released again and the brewing piston moved back into its initial position via the restoring means. The lifting of the locking is effected passively by way of the brewing piston which moves back forcing back the at least one locking body into a space which is released by the moved-back actuation element.

The individual assemblies or devices, such as water pump, valves, piston drive or grinder are controlled in particular by the control device. Control commands can be transferred to the control device via the input device.

Thus, as already mentioned further above, in particular the piston drive is also controlled via the control device. E.g. the amount or degree of the coffee pressing can be set via the input device or presetting. The control device then on the basis of the respective specifications for coffee pressing (degree or amount of coffee pressing) controls the pressing pressure (piston pressure) which is exerted upon the coffee powder, via the piston drive.

The coffee machine according to the invention is characterised by the following advantages:
individual setting of the coffee pressing thanks to the brewing piston which via the control device and by way of the piston drive can be advanced into the coffee receiving space or into the brewing chamber in a controlled manner;
thanks to the locking, no moving-back of the brewing piston during the brewing procedure despite a low piston pressure;
the locking of the brewing piston is effected via a drive which is already present.

The advantages of the portafilter device in particular are:
thanks to the movable brewing piston which permits an individual coffee pressing also given a different filling of the coffee receiving space with coffee powder, filter baskets of a different size are no longer necessary;
thanks to the movable brewing piston, it is not necessary to tighten the portafilter device against a (stationary) tamper on the machine unit for the pressing of the coffee.

### BRIEF DESCRIPTION OF THE DRAWINGS

The subject-matter of the invention is hereinafter explained in more detail by way of particular embodiment examples which are represented in the attached figures. In each case schematically are shown in:

FIG. 1a a perspective view of a first embodiment of an arrangement of the brewing unit and the grinder as well as a linear guide device and portafilter device of a portafilter machine, obliquely from the front;

FIG. 1b: a cross section through the arrangement according to FIG. 1a;

FIG. 1c: a further perspective view of the arrangement according to FIG. 1a obliquely from the rear;

FIG. 2: a perspective view of the portafilter device obliquely from above;

FIG. 3: a perspective view of the linear guide device according to FIG. 1a without the portafilter device, obliquely from below;

FIG. 4: a schematic view of a portafilter machine with an arrangement according to FIGS. 1a to 1c;

FIG. 5: a perspective view of the grinder according to FIG. 1a to 1c obliquely from below.

### DETAILED DESCRIPTION OF THE INVENTION

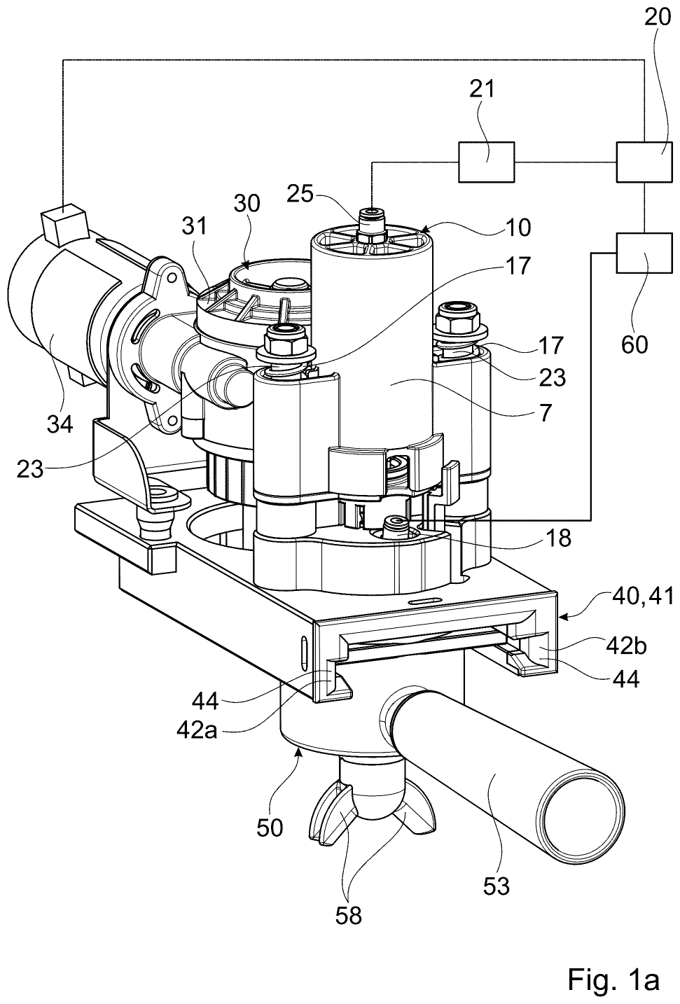

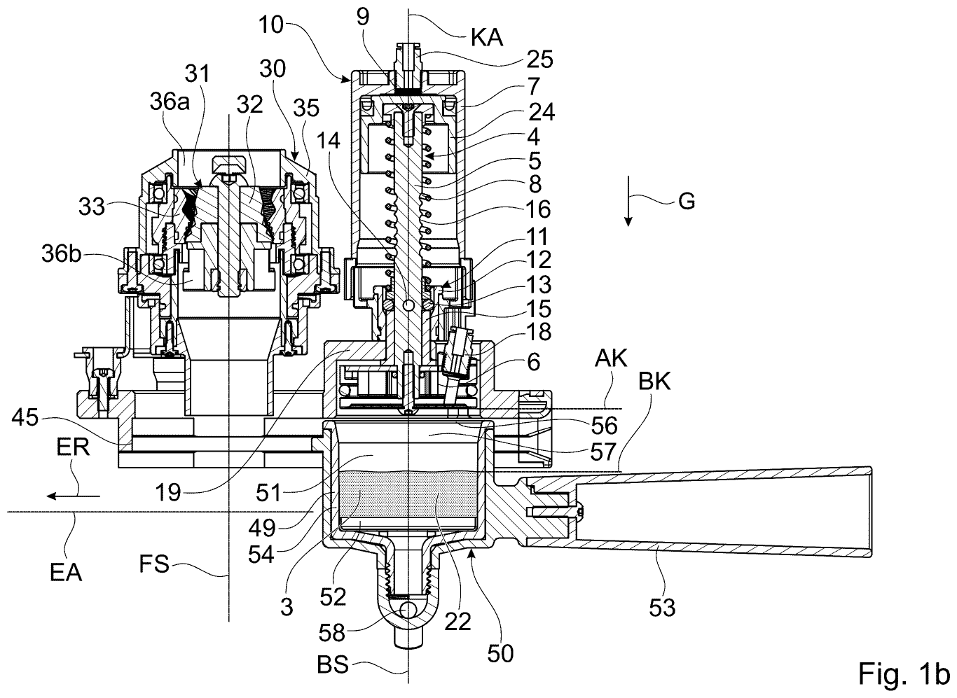

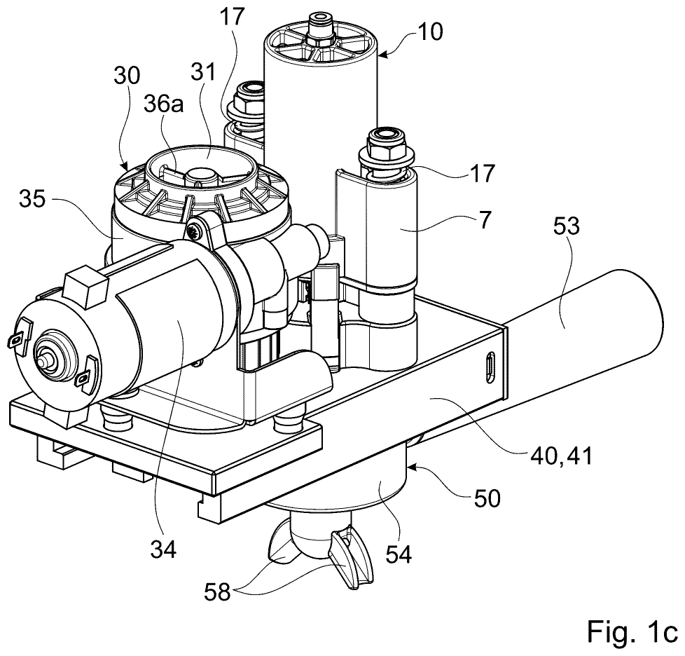

According to a first embodiment according to FIG. 1a to 1c, the coffee machine 1 includes a brewing unit 10 and a device for producing and delivering coffee powder 30 with a cone grinder 31. A holding and guiding device 40 with a linear guide device 41 is arranged below the brewing unit 10 and the device 30. The linear guide device 41 includes two guide rails 42a, 42b which run parallel to one another, are arranged at a distance to one another and each include a guide slot 44 for the sliding receiving of guide bars 55 on a portafilter device 50.

Moreover, the coffee machine 1 includes a portafilter device 50 with a portafilter housing 54 and with a grip body 53 for holding the portafilter device 50. Two guide bars 55 which run parallel to one another laterally on both sides of a receiving opening 56 are arranged on the portafilter device housing 54 at the outside for insertion into the guide slots 44 of the guide rails 42a, 42b.

The brewing unit 10 and the device 30 with the cone grinder 31 are arranged one after the other along the insertion axis EA, wherein the device 30 with the cone grinder 31 is arranged after the brewing unit 10 in the insertion direction ER.

The portafilter device 50 can be pushed into the machine unit 2 of the coffee machine 1 via the guide bars 55 which engage laterally into the guide slots 44 of the guide rails 42a, 42b. The machine unit 2 corresponds to the coffee machine 1 without the portafilter device 50.

The portafilter device 50 amongst other things can be pushed into a filling position FS in which the portafilter device 50 is arranged below the device 30, respectively the grinder 31. The holding and guiding device 40 forms an end stop 45 which represents an insertion limitation and simultaneously ensures the exact positioning of the portafilter device 50 in the filling position FS for filling the portafilter device 50 with coffee powder 22. This means that the portafilter device 50 assumes the filling position FS on reaching the stop 45.

The cone grinder 31 includes a multipart housing 35 in which the grinding cone 32 and the grinding ring 33 which surrounds the grinding cone 32 are arranged. Starting from the cone base, the grinding cone 32 tapers along the cone axis upwards. The grinding ring 33 is rotatably mounted in the housing 35 about the cone axis of the grinding cone 32 via bearings such as ball bearings and is driven via an electric motor 34. The grinding gap is formed between the grinding ring 33 and the grinding cone 32, into which grinding gap the coffee beans are fed from above and ground by the grinding ring which rotates about the cone axis. The ground coffee powder leaves the grinding gap at the lower end in the region of the cone base and drops downwards due to gravity.

The grinding cone 32 is arranged in a rigid, i.e. non-moved manner and is connected at its two cone ends to the housing 35 via several connection webs 36a, 36b. Coming from the cone axis, the connection webs 36a, 36b run radially outwards towards the housing 35 in a star-like manner.

Several through-openings for letting through coffee beans downwards into the cone grinder 31 in the direction of gravity G are formed at the upper end of the grinding cone (see FIG. 1c).

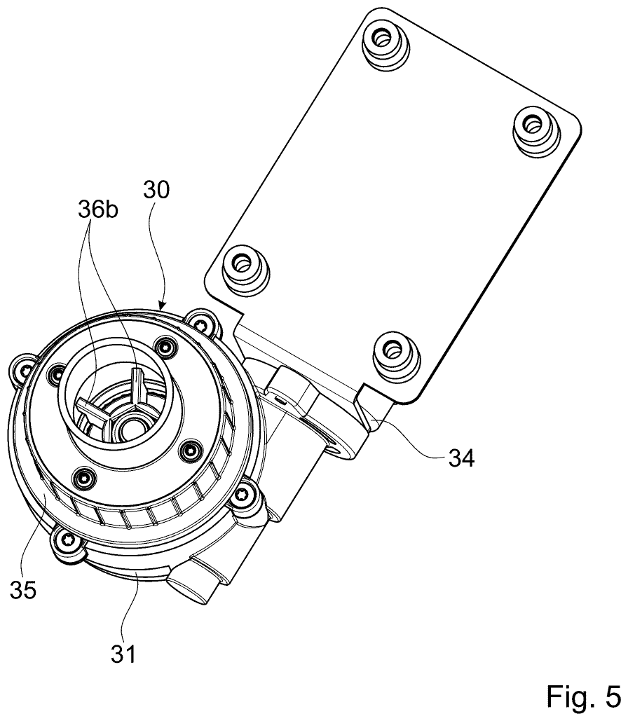

Several through-openings for letting through coffee powder 22 from the cone grinder 31 downwards into the coffee receiving space 51 of the portafilter device 50 in the direction of gravity G are formed at the lower end of the grinding cone, i.e. on the cone base between the connection webs 36b (see FIG. 5).

However, it is not absolutely necessary for the coffee machine to include an integrated grinder as is represented in the figures. In particular, this relates to portafilter machines. The grinder for example can also be arranged or attached on the coffee machine in a manner such that a portafilter device is filled with coffee powder already before the insertion into the machine unit or before the attachment on the machine unit. Moreover, it is also possible for the coffee machine to have no grinder and for the coffee powder to be obtained from a separate coffee mill or from a supply store.

The portafilter device 50 includes a filter basket 49 which is admitted into the portafilter housing 54, with a brewing filter 52 which forms the base of the filter basket 49. The filter basket 49 forms the coffee receiving space 51 for receiving the coffee powder 22. This is open to the top. Accordingly, the filter basket 49 includes a receiving opening 56 to the top. This lies opposite the brewing filter 52. The coffee receiving space 51 is designed in a cylindrical manner but in the region of the receiving opening 56 includes a circumferential, funnel-like widening 57. The filter basket 49 in this embodiment example is fixedly connected to the portafilter housing 54 and accordingly cannot be removed. The filter basket 49 however can also be removable. The filter basket 49 can likewise be an integral constituent of the portafilter housing 54.

Subsequently to the filling of the coffee receiving space 51 of the portafilter device 50 with coffee powder 22, the portafilter device 50 is retracted into the brewing position BS in a linear counter-movement via the linear guide device 41. In the brewing position BS, the portafilter device 50 is located below the brewing unit 10.

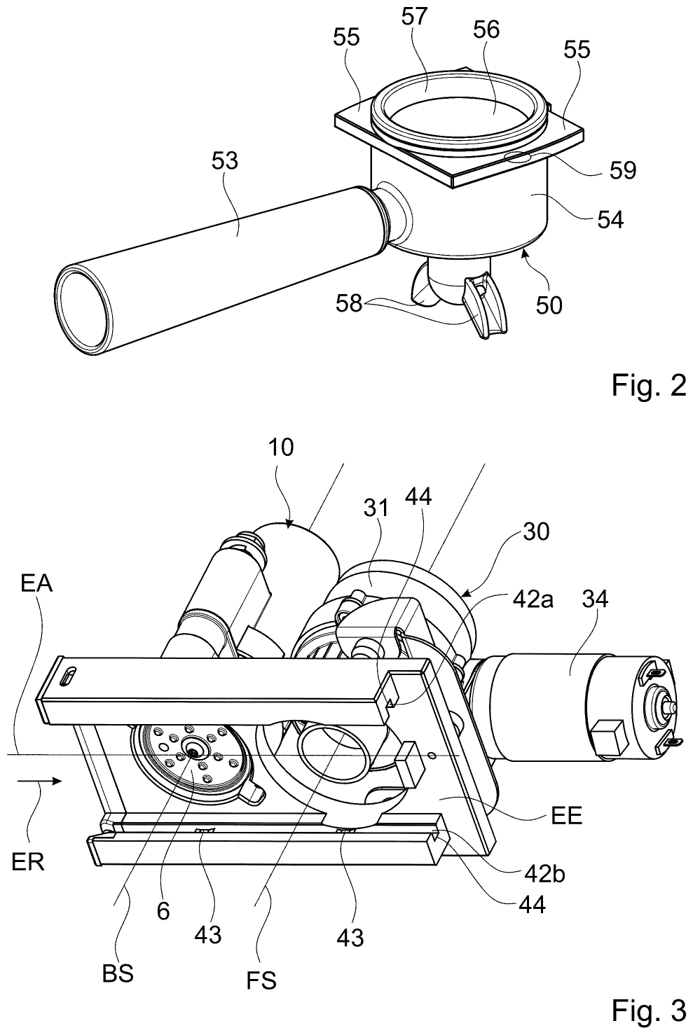

As can be seen more clearly from FIGS. 2 and 3, the linear guide device 41 and the portafilter device 50 includes latching means 43, 59 which cooperate with one another and which permit an exact, self-centring positioning of the portafilter device 50 in the brewing position BS. In the present embodiment example, latching notches 41 are formed in the guide slot 44 of the guide rails 42a, 42b, into which notches spring-loaded balls 59 which are arranged on the guide bars 55 of the portafilter device 50 engage. The latching notches 43 each form a run-in ramp in the insertion direction ER and counter to the insertion direction ER. This ramp is to reduce the force effort on pushing or pulling the portafilter device 50 out of the latching position, so that the portafilter device 50 can be pushed or pulled beyond the latching position or be pulled or pushed out of the latching position again without much effort.

Basically, the fastening of the portafilter device can also be effected via a conventional quick-release fastener, such as e.g. a bayonet fastener. An integrated grinder is likewise not compelling.

The brewing unit 10 includes a brewing piston 4 with a piston rod 5 which is guided in the piston rod housing 7 as well as a piston tamper 6 which is arranged at the lower end, i.e. towards portafilter device 50 and is guided in a piston tamper guide housing 19. The piston tamper guide housing 19 includes a piston rod guide tube 15 through which the piston rod 5 is led from the piston rod housing 7 into the piston tamper guide housing 19. The piston axis KA is perpendicular to the insertion direction ER or insertion plane EE of the portafilter device 50 and accordingly also runs perpendicularly to the receiving opening 56 of the portafilter device 50.

For initiating the brewing procedure, the brewing piston 4 is moved downwards out of its initial position AK towards the coffee receiving space 51 of the portafilter device 50 in the direction of gravity G by way of a piston drive 21. The piston tamper 6 is herein moved into the coffee receiving space 51 and presses or compresses the coffee powder together. In other words, the so-called tampering is carried out by the brewing piston 4. The advance of the brewing piston 4 is ended on reaching the brewing position BK. The coffee receiving space 51 which is closed by the piston tamper 6 now forms a brewing chamber 3.

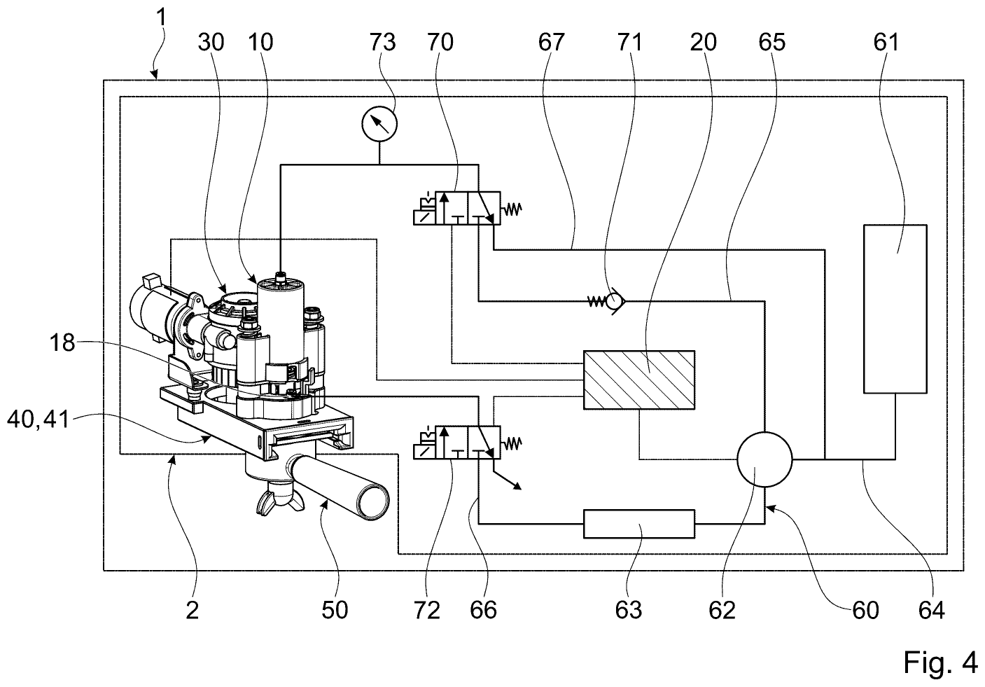

The piston drive 21 and herewith also the piston pressure which in turn is a measure of the coffee pressing are controlled via the control device 20. The piston drive 21 can be an electrical drive or a hydraulic drive. Concerning the latter, as is explained further below in more detail, a hydraulic fluid such as water is led into a pressure chamber 9 via a feed 25. A hydraulic drive of the brewing piston 4 can be effected via the water pump 62 of the brewing water preparation device 60 as is yet explained further below by way of FIG. 4.

The coffee machine or the machine unit 2 further includes a brewing water preparation device 60 with a water tank 61, a water pump 62 and a heating unit 63 for feeding hot water under pressure into the brewing chamber 3 (see also FIG. 4). The hot brewing water is led under pressure into the brewing chamber 3 via a brewing water feed 18 which is led through the piston tamper 6.

The portafilter device 50 includes a coffee outlet opening 58 which is arranged below the brewing filter 52. The coffee which is brewed in the brewing chamber 3 and is pressed through the brewing filter 52 flows away downwards through this, e. g. into a drinks vessel (not represented).

The brewing piston 4 interacts with a restoring spring 8. This spring in the present embodiment corresponds to a compression spring 8 in the form of a helical spring which surrounds the piston rod 5. The compression spring 8 which is pressed together on advancing the brewing piston 4 towards the portafilter device 50 presses the brewing piston 4 back again into its initial position AK after completion of the brewing procedure with the reduction of the piston pressure. Restoring means, such as restoring springs are not necessarily needed given a piston drive 21, such as e.g. an electrical drive which actively moves back the brewing piston 4.

The brewing piston 4 further includes a piston guide sleeve 24, by way of which the brewing piston 4 is axially guided in the piston rod housing 7. The piston guide sleeve 24 is arranged in the upper end section of the brewing piston 4 towards the pressure chamber 9.

According to the present embodiment, the brewing piston 4 is locked in the brewing position BK with respect to an axial direction which is opposite to the advance direction of the brewing piston 4, by way of a locking device 11. The locking amongst other things serves for the relieving of the piston drive 21. Thus, the piston pressure which is exerted upon the brewing piston 4 by the piston drive 21 for pressing the coffee powder 22 is significantly lower than the brewing water pressure which is built up in the brewing chamber by the water pump 62 of the brewing water preparation device 60 and which acts upon the brewing piston 4 as a counter-pressure. Thanks to the locking of the brewing piston 4 during the brewing procedure, one does not need to build up a counter-pressure which corresponds to the brewing water pressure, with the piston drive. However, the locking device 11 is not absolutely necessary. Moreover, a locking can also be effected itself by the piston drive 21.

The embodiment according to FIG. 1a to 1c shows a particular embodiment of a locking device which is characterised in that this is likewise activated via the piston drive 21.

In the present case, the piston drive 21 by way of a hydraulic fluid and via a hydraulic pump exerts a hydraulic pressure onto the brewing piston 4. For this, a hydraulic fluid is led into a pressure chamber 9 via a feed 25 such as a piston water feed, said pressure chamber amongst other things being delimited by the movable brewing piston 4. The pressure chamber 9 is not particularly evident in FIG. 1b since this does not extend spatially downwards into the brewing position BK until the movement of the brewing piston 4 downwards out of its initial position AK.

As is yet explained in more detail by way of FIG. 4, the hydraulic pump can also correspond to the water pump 62 of the brewing water preparation device 60 and the hydraulic fluid can be water from the water tank 61 of the brewing water preparation device 60.

On account of the pressure of the hydraulic fluid (e.g. water) which flows into the pressure chamber 9, the brewing piston 4 moves downwards out of its initial position AK in the direction of the portafilter device 50 into the brewing position BK counter to the restoring force of the restoring spring 8.

The pressure chamber 9 is delimited to the top by the piston rod housing 7. The piston rod housing 7 via two connection screws 23 is axially movably mounted relative to the piston tamper guide housing 19 and accordingly with respect to the piston rod guide tube 15, along the connections screws 23. The connection screws 23 accordingly form an in particular thread-free guide section for the axial guidance of the axially movable piston rod housing 7. The piston rod housing 7 is held in an initial position via two compression springs 17 which press the piston rod housing 7 downwards. The compression springs 17 are designed as helical springs and each surround the connection screws 23.

The axial movement of the brewing piston 4 downwards is completed on reaching the brewing position BK. The pressure which increases further in the pressure chamber 9 now exerts a corresponding force upon the piston rod housing 7, by which means this is moved slightly upwards counter to the restoring force of the compression springs 17, in a direction which is counter to the piston movement.

An annular actuation element 12 of the locking device 11 which is likewise moved upwards and surrounds the piston rod guide tube 15 is also connected to the piston rod housing 7. The actuation element 12 in an upper section forms a radial distance to the piston rod guide tube 15, by which means an annular cavity or gap arises. In a lower section, the actuation element 12 is in sliding contact with the piston rod guide tube 15 and bears on this. The upper and the lower section merge into one another by way of a guide ramp.

The piston rod guide tube 15 includes radial through-openings 14 at the height of the actuation element 12, into which through-openings ball bodies 13 are movably mounted.

The piston rod 4 includes a plurality of recesses 16 which are arranged along the piston axis KA, are each annularly peripheral and into which the ball bodies 13 can engage.

In the non-locked position, the piston rod housing 7 and with this the actuation element 12 is held in a lower initial position by way of the restoring force of the compression springs 17. The upper section of the actuation element 12 with the annular cavity or gap is located at the height of the radial through-openings 14. The ball bodies 13 are set back from the radial through-openings 14 and engage into the annular cavity.

If now the brewing piston 4 reaches the brewing position BK, then as mentioned the piston rod housing 7 is slightly lifted together with the actuation element 12 in the axial direction. By way of this, the lower section of the actuation element 12 together with the annular gap moves upwards, by which means the ball bodies 13 are displaced back radially inwards into the through-openings 14 due to the lower section which likewise moves upwards. The guide ramp between the upper and the lower section ensures that the ball bodies 13 do not jam with the actuation element 12, but rather move uniformly into the through-openings 14.

The ball bodies 13 which are displaced back into the radial through-openings 14 now at the other side engage into a recess 16 on the piston rod 15 and effect the locking of the brewing piston 4 in the brewing position BK. The ball bodies 13 consequently act as locking bodies.

The locking remains as long as the hydraulic pressure in the pressure chamber 9 is capable of pressing the piston rod housing 7 upwards against the restoring force of the compression springs 17.

After completion of the brewing procedure, the pressure in the pressure chamber 9 is reduced, by which means the piston rod housing 7 moves back downwards together with the actuation element 12 into the initial position due to the restoring force of the compression springs 17. The upper section of the actuation element 12 together with the annular gap between the actuation element 12 and the piston rod guide tube 15 comes to lie again at the height of the radial through-openings 14.

On account of the reduction of the pressure in the pressure chamber 9, again the restoring force upon the brewing piston 4 which is exerted by the compression spring 8 is dominant. The ball bodies 13 are displaced back out of the recess 16 into the radial through-holes 14 and into the annular gap which lies behind this due to the pressing force of the compression spring 8 or due to the brewing piston 4 which is brought into an upwards movement by the compression spring 8.

The locking is lifted and the brewing piston 4 springs back upwards into the initial position AK due to the restoring force of the compression spring 8.

FIG. 4 shows a particular further development of the coffee machine 1 which is characterised in that the brewing piston 4 is driven by the water pump 62 of the brewing water preparation device 60, which is to say advanced in the brewing position BK. The water pump 62 obtains water from the water tank 61 via a feed water conduit 64. The water pump 62 is connected to the brewing water feed 18 on the piston tamper 6 via a brewing water conduit 66. A heating unit 63, i.e. a thermo-block or continuous heater is arranged along the brewing water conduit 66 for heating the brewing water which flows through the brewing water conduit 66. The water pump 62 pumps water out of the water tank 61 under pressure into the brewing chamber 3 via the brewing water conduit 66. The brewing water is heated by the heating unit 63 on its way through the brewing water conduit 66.

A 3/2-way valve 72 is arranged on the brewing water conduit 66, the valve including a further connection for the discharge of residual water into a capture container such as a drip tray, subsequently to the brewing procedure. The 3/2-way valve 72 is switched via the control device 20.

The water pump 62 is further connected to the piston water conduit 65 via which water is pumped out of the water tank 61 into a pressure chamber 9 in the piston rod housing 7 (see FIG. 1b) for advancing the brewing piston 4 from the initial position AK into the brewing position BK.

The piston water conduit 65 includes a check valve 71 which prevents the backflow of water out of the pressure chamber 9 into the water pump 62. Moreover, a 3/2-way valve 70 is arranged in the piston water conduit 65 between the check valve 71 and the pressure chamber 9. A return water conduit 67 via which piston water can be led back into the water tank 61 is connected to the 3/2-way valve 70. A manometer 73 for monitoring the pressure in the pressure chamber 9 is situated on the piston water conduit 65.

For advancing the brewing piston 4 from the initial position AK into the brewing position BK, the water pump 62 pumps water out of the water tank 61 into the piston water conduit 65 and builds up a piston pressure which is specified by the control device 20.

After the brewing piston 4 has reached its brewing position BK and is locked, the water pump 62 amid heating pumps water out of the water tank 61 through the brewing water conduit 66 into the brewing chamber 3 and builds up a brewing pressure which as a rule is greater than the piston pressure.

The water pump 62 is switched between the piston water conduit 65 and the brewing water conduit 66 or between the piston water feed and the brewing water feed via the control device 20. The check valve 71 in the piston water conduit 65 prevents a pressure loss in the pressure chamber 9 on switching the water pump 62 from the piston water conduit 65 to the brewing water conduit 66.

The pressure in the brewing water conduit 66 is relieved at the end of the brewing procedure and the 3/2-way valve is switched by the control device 20 such that the residual water is discharged into a capture container (not shown).

Furthermore, the pressure is also relieved in the piston water conduit 65 and the 3/2-way valve 70 is switched such that the piston water is led back into the water tank 61 via the feed-back water conduit 67.

1. A coffee machine, comprising a machine unit with:
control device for control of the coffee machine,
a brewing piston which is movably mounted between an initial position and a brewing position,
a piston drive which can be controlled via the control device, for moving the brewing piston from the initial position into the brewing position, and with
a water preparation device with a water tank, a water pump and a heating unit, for generating and delivering hot brewing water under pressure into a brewing chamber,
wherein the coffee machine comprises a locking device with at least one locking body for locking the brewing piston in the brewing position.

2. The coffee machine according to claim 1, wherein the locking device can be actuated via the piston drive.

3. The coffee machine according to claim 1, wherein the piston drive is a hydraulic drive.

4. The coffee machine according to claim 1, wherein the piston drive is formed by the water ump of the water preparation device.

5. The coffee machine according to claim 1, wherein the locking device can be actuated by the water pump of the water preparation device.

6. The coffee machine according to claim 1, wherein the locking device comprises an actuation element which is movable parallel to the piston axis of the brewing piston and the at least one locking body is movable towards the brewing piston into a locking position via the actuation element.

7. The coffee machine according to claim 2, wherein the coffee machine is designed such that for initiating a brewing procedure, the piston drive in a first step moves the brewing piston into a brewing position and in a second step after reaching the brewing position actuates the locking device amid the locking of the brewing piston.

8. The coffee machine according to claim 2, wherein the coffee machine is designed such that for initiating a brewing procedure, the piston drive in a first step moves the brewing piston into a brewing position whilst pressing the coffee powder by way of applying a pressing force and in a second step on reaching a maximal pressing force with the assumption of the brewing position actuates the locking device amid the locking of the brewing piston.

9. The coffee machine according to claim 2, wherein the machine unit comprises a piston rod housing which is movably mounted along the piston axis and which interacts with the actuation element of the locking device, wherein the piston rod housing and the brewing piston are designed and interact, in a manner such that in a first step the piston drive advances the brewing piston in the axial direction towards the brewing chamber into the brewing position and subsequently in a second step displaces the piston rod housing in the opposite, axial direction amid the actuation of the locking device.

10. The coffee machine according to claim 3, wherein the machine unit comprises a piston rod housing which is axially movably mounted along the piston axis, and which interacts with the actuation element of the locking device and together with brewing piston forms a pressure chamber, wherein the piston rod and the brewing piston (4) are designed and interact, in a manner such that a piston fluid pressure, which is generated in the pressure chamber advances the brewing piston in the axial direction towards the brewing chamber into the brewing position and subsequently displaces the piston rod housing in the opposite, axial direction amid the actuation of the locking device.

11. The coffee machine according to claim 1, wherein the at least one locking body is a ball body which is guided in a radial opening of a piston rod guide tube and which in the locking position engages into a deepening on the brewing piston.

12. (canceled)

13. The coffee machine according to claim 3, wherein the brewing piston interacts with restoring spring, by way of which the brewing piston can be moved back from the brewing position into the initial position after reduction of the piston fluid pressure.

14. The coffee machine according to claim 10, wherein the piston rod housing interacts with at least one restoring spring, by way of which the piston rod housing can be moved back in the direction of the brewing chamber into its initial position after the reduction of the piston fluid pressure.

15. The coffee machine according to claim 3, wherein the water pump of the water preparation device is hydraulically connected:
to a water tank via a feed water conduit for obtaining water,
to the brewing piston via a piston water conduit for displacing the brewing piston, and
to the brewing chamber via a brewing water conduit for brewing coffee.

16-17. (canceled)

18. The coffee machine according to claim 15, wherein a check valve for maintaining the built-up piston water pressure is arranged in the piston water conduit between the water pump and a directional valve.

19. (canceled)

20. A method for brewing a coffee with a coffee machine according to claim 1, comprising the steps of:
for carrying out a brewing procedure, advancing the brewing piston by way of the piston drive in the direction of the coffee receiving space, which is filled with coffee powder, and
actuating the locking device on reaching the brewing position and locking the brewing is locked piston with respect to an axial movement which is directed away from the brewing chamber, and
delivering brewing water into the brewing chamber by way of the water pump amid the build-up of a brewing water pressure and carrying out the brewing procedure.

21. The method according to claim 20, further comprising building up a piston water pressure which acts upon the brewing piston by way of the water pump and advancing the brewing piston in the direction of the coffee receiving space by way of the piston water pressure.

22. The method according to claim 20, wherein the brewing piston acts as a coffee presser and presses together the coffee powder in the coffee receiving space.

23. The method according to claim 20, wherein the pressing pressure which is exerted upon the coffee powder by the brewing piston is lower than the brewing water pressure which is exerted onto the brewing piston in the opposite direction during the brewing procedure.

24. The method according to claim 21, wherein the water pump obtains the water for the build-up of a piston water pressure from the water tank via the feed water conduit and pumps this as piston water into the piston water conduit.

25. The method according to claim 20, wherein for building up a brewing water pressure in the brewing chamber, the water pump obtains water from the water tank via the feed water conduit and pumps this as brewing water into the brewing water conduit.

26. The method according to claim 21, wherein the generated piston water pressure is maintained up to the end of the brewing procedure and after completion of the brewing procedure is reduced again for the purpose of lifting the locking and for moving the brewing piston back into its initial position.

27-28. (canceled)

29. The method according to claim 21, wherein the directional valve is switched via the control device for reducing the piston water pressure and for discharging or leading back piston water.

30. The method according to claim 21, wherein the piston water pressure is reduced at the end of the brewing procedure and as a result of which the locking is released and the brewing piston is subsequently moved back into its initial position (AK) via a restoring spring.

31. (canceled)
